(19) United States
(12) Patent Application Publication
(10) Pub. No.: US 2013/0098862 A1
(43) Pub. Date: Apr. 25, 2013

(54) Multi-Function of Intelligence Milk Bottle Design

(71) Applicant: Jie-Feng Yi, (US)

(72) Inventor: Jie-Feng Yi, (US)

(21) Appl. No.: 13/279,343

(22) Filed: Oct. 24, 2011

(51) Int. Cl. A61J 9/02; A61J 9/08; B67D 7/80; A61J 9/06

(52) U.S. Cl. 215/11.2; 222/146.5

(57) ABSTRACT

This invention offers a multi-function of intelligence milk bottle design. The technique of it is that a bottle body composed of tooth screw, outer main body, nipple, and bottle body; said tooth screw and outer main body forms a space and the space contains a Intelligence Temperature Controller. This invention of Intelligence Temperature Controller can control the liquid temperature and show the temperature on screen; this milk bottle can also connect with electricity to regulate the heating time and temperature; in addition, this milk bottle can have heating disinfection device to turn on the bottle cover and heat up or cleanse the nipple. In addition, this invention can have health, safety, heat proof, better quality, heat preservation, etc.

### FIELD OF THE INVENTION

This invention involves the life equipment filed, which refers to multi-function of intelligence milk bottle design.

### DESCRIPTION OF PRIOR ARTS

There are many types of milk bottles, and all of them are made from glass or plastic material; however, these two material do not have the function of temperature detecting, temperature display, and heating; these nipples can only have the function of fill.

The milk bottles on sale are composed of bottle body and screw, which closely connect with nipple, and the structure is simple, easy for production, and low-cost, but the problem are as follows:
1. Plastic milk bottle is not heat proof; when the temperature is high, the main body deforms easily; the milk bottle is also bad for heat resistance to case the problem of heat-burnt, smelly, and poisonous.
   Glass milk bottle is fragile and bad for heat-resistance; the more the liquid is, the hotter the main body is; thus it is easy to have heat-burnt.
2. The milk bottles on sale can feed the baby, but the liquid temperature is not known; it is not sanitary, and not convenient for users to taste the liquid or test with skin to know the temperature; this behavior can cause baby's infection and bad for baby's health.
3. It is not easy to clean the milk bottle; most of the time, users fill the milk bottle with water to clean, but it is not thoroughly clean; some milk bottle can only stand low temperature to clean; thus, it is hard to clean the milk bottle thoroughly.
4. The general milk bottle does not have the heating function, and can only heat the liquid; even though the milk bottle can preserve the temperature for a while, it will cool down as time goes by; thus, it is a problem for users.

### SUMMARY OF THE INVENTION

First, the Technique of this Invention:

This invention is the improvement of general milk bottle, and adopts a double-side stainless steel of multi-function of intelligence milk bottle design. To solve the problem above and reach the aim of this invention, the embodiment of this multi-function of intelligence milk bottle design is characteristic in that: said milk bottle includes:

A multi-function of intelligence milk bottle design, which is characteristic in that: bottle body (1) composed of internal bile (12), outer main body (11), nipple (2) and bottle cover (3) on the top; said internal bile (12) and outer main body (11) has a space to show intelligence temperature controller (5) of internal bile (12).

According to the description above, a multi-function of intelligence milk bottle design is characteristic in that: said outer main body (11) has a power source consent (15) of power source equipment (6).

According to the description above, a multi-function of intelligence milk bottle design is characteristic in that: said intelligence temperature controller (5) includes: energy-saving switch (52), display screen (51) of outer main body (11), battery base (53) of outer main body (11).

According to the description above, a multi-function of intelligence milk bottle design is characteristic in that: said outer main body (11) has a battery lid (16), which connects with outer main body (11), and said battery lid (16) connect with battery base (53) through electric silicone.

According to the description above, a multi-function of intelligence milk bottle design is characteristic in that: said (6) of (15) includes: a (61), which controls time and temperature, (62) of (61), and (63).

According to the description above, a multi-function of intelligence milk bottle design is characteristic in that: said body (611) of temperature controller (61) is situated on left knob (612), and right knob (613), which controls the heating time.

According to the description above, a multi-function of intelligence milk bottle design is characteristic in that: said internal bile (12) has a low pressure heating membrane (8), which connects closely with internal bile (12), and said Power source consent (15).

According to the description above, a multi-function of intelligence milk bottle design is characteristic in that: said milk bottle contains heating disinfection device (7), which includes a main body (74), cover (71), heating pipe (72) of cover (71), and USB plug (73).

According to the description above, a multi-function of intelligence milk bottle design is characteristic in that: said bottle body (1) has a opening (14), which includes: internal bore (141) of internal bile (12), and exterior bore (142) of outer main body (11).

According to the description above, a multi-function of intelligence milk bottle design is characteristic in that: said opening (14) has a silicone gum (4), and on the margin of bottle body (1), there are internal bore (141) and exterior bore (142); silicone gum (4) closes internal bore (141) and exterior bore (142).

### Second: Comparison of Prior Art:

1. This invention has the function of temperature detecting and display because the milk bottle is equipped with intelligence temperature controller on main body, so users can know the liquid temperature without testing it by skin or mouth; thus it is convenient, clean, and heath for child without the cross infection.
2. This invention is equipped with intelligence temperature display and a switch on main body; when use, users can turn on the switch, and the temperature shows when the liquid is filled on bottle; the LCD screen can show the liquid temperature automatically. Said switch is touched device, made with silicone to prevent vibration touch. The chip can have power stop after 2 minutes.
3. This invention is designed with heating function; open the milk bottle and heat up; the cover of heater can closely connect with bottle, and the heating pipe insert into internal bile; once it is connected with electricity, the users can disinfect the internal bile within 3 to 5 minutes; when the water is lower than 100 ml, it will automatic power stop; hit the dry-up bottom, the bone can have power stop after 1 minutes.
4. The display screen shows from 10 C to 99 C, and the works at −10 C to 65 C; when the temperature is lower than 35 C, the letters show yellow and alarm a little bit; when the temperature is 35 C to 40 C, it is green letters without alarm; LED display screen turn on automatically to normal; LCD display turn off with black letters. Said alarm has one of the followings: a. soft music; b. vocal notice; c. hymning alarm sound; it is convenient to use.
5. The battery for this invention is CR2450, 3V, and 600 Mah. It is guarantee for 1 year without change. This battery is in common use, and is it easy to replace with standard battery.
6. This invention is good in heat proof, and adopts the double layer stainless steel; even the liquid is high, it will not get hot deforms on main body.
7. This invention is good in quality, and it is unbreakable; the main body and cover are break proof, and pressure proof; moreover, the main body is equipped with break proof silicone.
8. This invention is good in heat preservation. This invention adopts internal bile, outer main body, and water proof silicone; it is a sealed with its facet and is heat preservation.
9. This invention is environmental, and this invention adopts SUS304 material, and high quality silicone; thus it can be repeatedly use without toxic, smelly, transparent, long-term, and durable to high and low temperature.
10. This invention is constant in temperature function; by applying left bottom to control temperature, and left bottom to control heating time; thus, users can control temperature and time to keep the liquid in a reason range.
11. This invention adopts double-side stainless steel structure, and it is heat preservation, unbreakable, sanitary, etc.

### DETAILED DESCRIPTION OF THE PREFERRED EMBODIMENTS

According to the figures, the embodiments are as follows:

First embodiment, as FIG. 1-3 shows, a double-side stainless steel multi-function of intelligence milk bottle design contains: a nipple (2) and bottle cover (3) on the top of bottle body (1) and opening (14); and a transparent silicone gum (4) on opening (14) of bottle body (1) through silicone gum (4) to opening (14).

In more detail, said bottle body (1) is composed outer main body (11), internal bile (12), and tooth screw (13); the up and side part of outer main body (11) has a design of break proof silicone (9).

Said nipple (2) includes: tooth screw (13) and inner cap (21), which connects closely with external lid (22) of inner cap (21) and tip (23).

Said internal bile (12) and outer main body (11) has a space and the space has an intelligence temperature controller (5).

Said intelligence temperature controller (5) includes: energy saving switch (52), display screen (51), and battery base (53).

Said opening (14) includes: internal bore (141) of internal bile (12) and exterior bore (142) of outer main body (11).

Said exterior bore (142) extends to bottle body (1) to make snap ring (17); said internal bore (141) extends to bottle body (1) to make snap ring (18).

Said silicone gum (4) is in strip shape, and alongside, there is groove (41) of internal bore (141) and snap ring (18); there is a groove position (42) on the side of silicone gum (4).

Said groove (41) is formed by front-end groove (411) and posterior-end groove (412); front-end groove (411) has a shape of said groove position (42), and said front-end groove (411) connects between outer main body (11) and Internal bile (12); posterior-end groove (412) and internal bore (141) connects between outer main body (11) and internal bile (12); posterior-end groove (412) and internal bore (141) connects closely to said snap ring (18) of internal bore (141) in groove (41) of silicone gum (4); snap ring (17) of exterior bore (142) connects to groove position (42).

For the second embodiment, as FIG. 4-7 shows, this second embodiment is different from first embodiment is that:

Said internal bile (12) and outer main body (11) has a space; said space has a intelligence temperature controller (5);

Said outer main body (11) has a power source consent (15), and said power source consent (15) can connect with power source equipment (6); said bottle body (1) has a replaceable heating disinfection device (7).

Said intelligence temperature controller (5) includes: energy saving switch (52), display screen (51) of outer main body (11), and battery base (53) of outer main body (11);

Intelligence temperature controller (5) has a design of buzzer (54). Said outer main body (11) has a battery lid (16) connects with battery base (53); said battery lid (16) can closely connect with battery base (53).

Said power source equipment (6) includes: a temperature controller (61), which controls time and temperature, power source plug (62) of temperature controller (61), and USB plug (63). Said temperature controller (61) includes body (611), left knob (612), and right knob (613).

The bottom side of said internal bile (12) is equipped with low pressure heating membrane (8), and low pressure heating membrane (8) connects with said power source consent (15).

Said heating disinfection device (7) includes: a main body (74), cover (71), heating pipe (72), and USB plug (73). Said main body (74) has a transformer and there is a switch, dry switch, and disinfection key.

When it is equipped, open battery lid (16) of outer main body (11) to put into battery base (53) and have battery lid (16);

When it is used, turn on energy saving switch (52) and start intelligence temperature controller (5) to make intelligence temperature controller (5) heating; the temperature shows on display screen (51) of outer main body (11). When the milk bottle stops, the chip will automatically stop within 2 minutes; intelligence temperature controller (5) will also stop.

This switch can prevent to be turned on while vibration.

When use power source equipment (6), the switch can connect power source plug (62) of temperature controller (61) to stick on power service consent (15) of outer main body (11) and inset USB plug (63) to other computer or USB plug; through regulation, the switch can control the heat time and temperature by left knob (612) and right knob (613).

In addition, said power source equipment (6) can have better temperature preservation; by controlling left knob (612) and right knob (613), the users can control the heating time and its temperature.

When use heating disinfection device (7), the users can put cover (71) on the top of milk bottle; cover (71) can connect with tooth screw (13) to make heating disinfection device (7) and milk bottle connect; heating pipe (72) of heating disinfection device (7) is in internal bile (12) of bottle milk. Insert the USB of heating disinfection device (7) into USB plug (73) or other computer USB.

Turn on the switch and heating disinfection device (7) and press the sanitary key to clean internal bile with 3 to 5 minutes; when the liquid is lower than 100 ml, the milk bottle will stop;

Choose the dry key, the milk bottle will automatically stop within 1 minutes; the users can put tip (23) into milk bottle; the length of heating tube is longer to prevent from burning out.

For the function above, display screen (51) displays as follows: display screen (51) shows the range of 10 C to 99 C degrees and the normal temperature from −10 C to 65 C; when the temperature is lower than 35 C, the word color shows yellow; when the temperature is higher than 40 C, the word color shows red; when the temperature is in green of 35 C to 40 C, there is no alarm;

Once the LED turns off for 5 seconds, it changes to other temperature; and the Led and alarm shifts back to normal:

Once the LED turned off, it shows the black word temperature.

Said alarm and voice are as follows:

a. Soft music, b. vocal reminder, C. alarm; it is convenient to use.

According to the figures and embodiment above, this invention is qualified with progressiveness and novelty to apply Patent; said above are better example of this invention, but not limited; any invention fits to this invention belongs to this invention scope.

### BRIEF DESCRIPTION OF THE DRAWINGS

FIG. 1: shows the main view of first embodiment;

FIG. 2: shows the sectional view of first embodiment;

FIG. 3: shows the stereogram view of first embodiment;

FIG. 4: shows the stereogram view of second embodiment;

FIG. 5: shows the sectional view of second embodiment;

FIG. 6: shows the layout of nipple and power source of second embodiment;

FIG. 7: show the conceptual diagram of heating disinfection device of second embodiment.

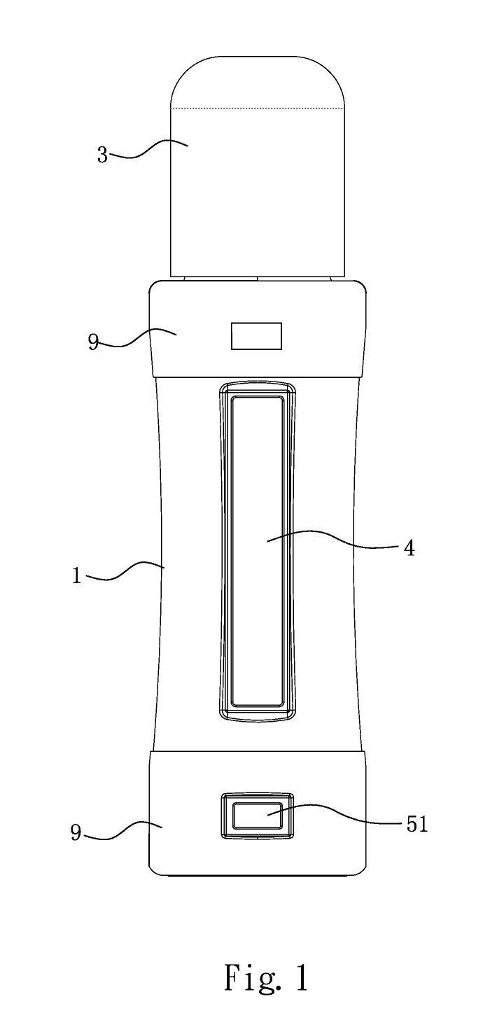

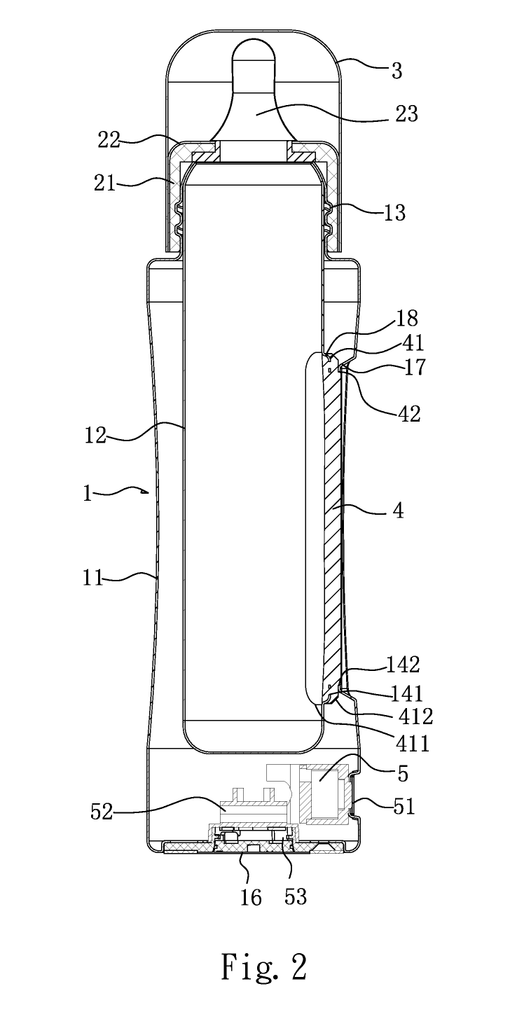

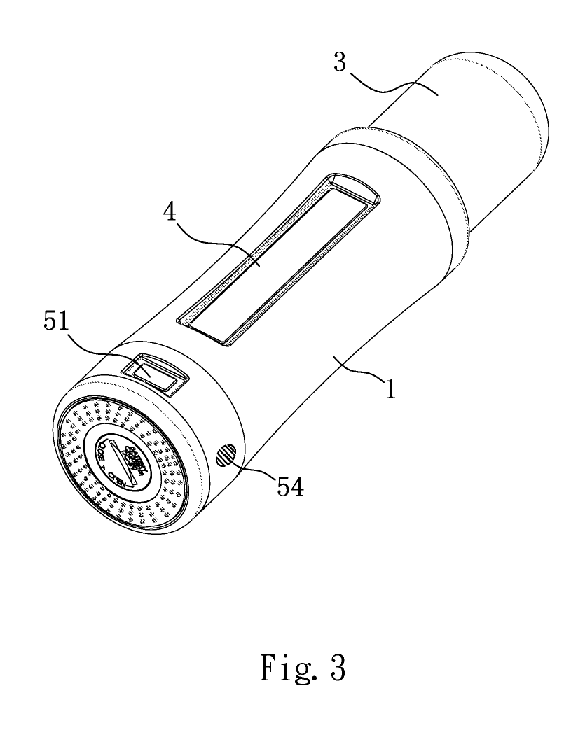

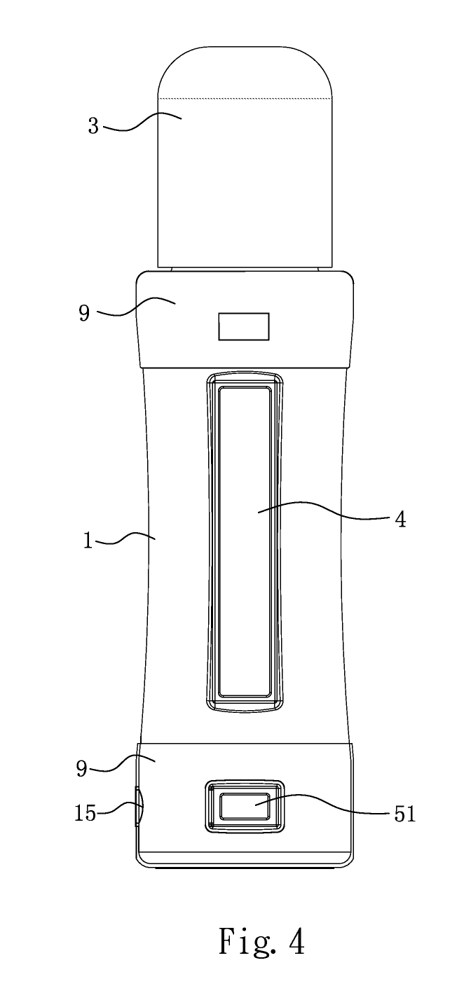

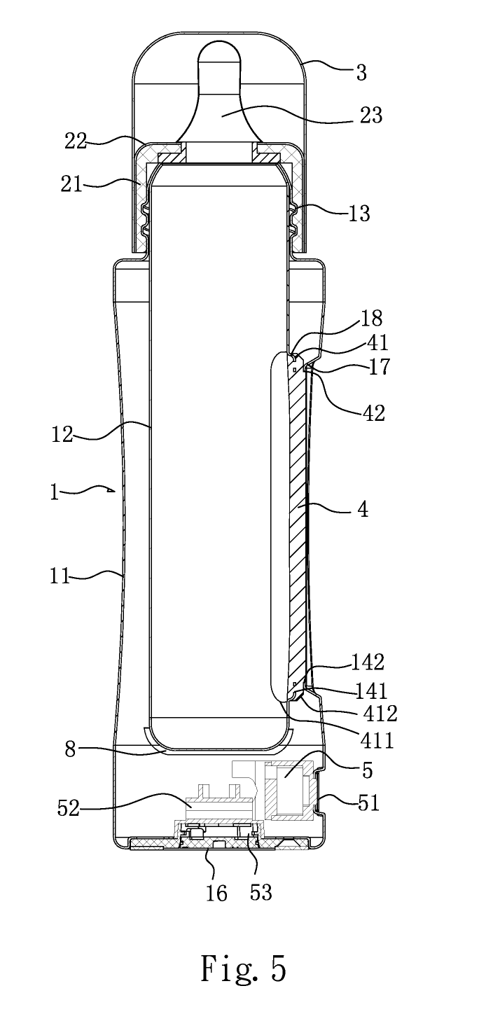

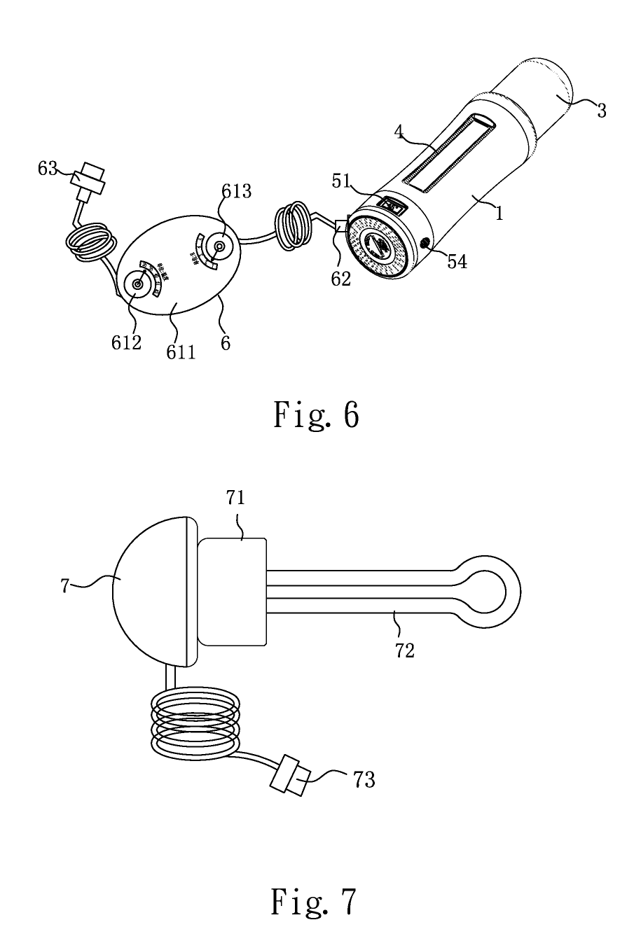

What is claim is:

1. A multi-function of intelligence milk bottle design, which is characteristic in that: bottle body (1) composed of internal bile (12), outer main body (11), nipple (2) and bottle cover (3) on the top; said internal bile (12) and outer main body (11) has a space to show intelligence temperature controller (5) of internal bile (12).

2. A multi-function of intelligence milk bottle design, according to claim 1, is characteristic in that: said outer main body (11) has a power source consent (15) of power source equipment (6).

3. A multi-function of intelligence milk bottle design, according to claim 1, is characteristic in that: said intelligence temperature controller (5) includes: energy saving switch (52), display screen (51) of outer main body (11), battery base (53) of outer main body (11).

4. A multi-function of intelligence milk bottle design, according to claim 3, is characteristic in that: said outer main body (11) has a battery lid (16), which connects with outer main body (11), and said battery lid (16) connect with battery base (53) through electric silicone.

5. A multi-function of intelligence milk bottle design, according to claim 2, is characteristic in that: said power source equipment (6) of power source consent (15) includes: a temperature controller (61), which controls time and temperature, power source plug (62) of temperature controller (61), and USB plug (63).

6. A multi-function of intelligence milk bottle design, according to claim 5, is characteristic in that: said body (611) of temperature controller (61) is situated on left knob (612), and right knob (613), which controls the heating time.

7. A multi-function of intelligence milk bottle design, according to claim 2, is characteristic in that: said internal bile (12) has a low pressure heating membrane (8), which connects closely with internal bile (12), and said power source consent (15).

8. A multi-function of intelligence milk bottle design, according to claim 1, is characteristic in that: said milk bottle contains heating disinfection device (7), which includes a main body (74), cover (71), heating pipe (72) of cover (71), and USB plug (73).

9. A multi-function of intelligence milk bottle design, according to claim 1, is characteristic in that: said bottle body (1) has a opening (14), which includes: internal bore (141) of internal bile (12), and exterior bore (142) of outer main body (11).

10. A multi-function of intelligence milk bottle design, according to claim 9, is characteristic in that: said opening (14) has a silicone gum (4), and on the margin of bottle body (1), there are internal bore (141) and exterior bore (142); silicone gum (4) closes internal bore (141) and exterior bore (142).
